(19) United States
(12) Patent Application Publication
(10) Pub. No.: US 2011/0198240 A1
(43) Pub. Date: Aug. 18, 2011

(54) Sensors and Methods for Detecting Organic Carbonyl Species

(76) Inventors: Gerardo A. DIAZ-QUIJADA, Ottawa (CA); Danial D.M. WAYNER, Ottawa (CA); Trevor MISCHKI, Ottawa (CA); Bhavana DEORE, Ottawa (CA)

(21) Appl. No.: 13/024,820

(22) Filed: Feb. 10, 2011

Related U.S. Application Data
(60) Provisional application No. 61/282,447, filed on Feb. 12, 2010.

(51) Int. Cl. G01N 27/28

(52) U.S. Cl. 205/782; 204/400

(57) ABSTRACT

A method for detecting an organic carbonyl species involves exposing a metal oxide-free film of a polyaniline to an environment suspected of containing an organic carbonyl species, detecting a change in electrical conductivity and/or an optical or luminescent property of the polyaniline, and, correlating the change in electrical conductivity and/or optical or luminescent property to a presence of the organic carbonyl species in the environment. Further, sensors for organic carbonyl species are disclosed having a metal oxide-free film of a polyaniline supported on an electrically insulating substrate. The method and sensors provide a good balance between response time and sensitivity, being considerably faster than metal oxide and metal oxide/polymer based sensors, while having greater sensitivity than other polymer-based sensors.

### CROSS-REFERENCE TO RELATED APPLICATIONS

This application claims the benefit of U.S. Provisional Patent Application 61/282,447 filed Feb. 12, 2010, the entire contents of which his herein incorporated by reference.

### FIELD OF THE INVENTION

The present invention relates to sensors and methods for detecting organic carbonyl species, particularly aldehydes and ketones.

### BACKGROUND OF THE INVENTION

Chemical sensors that exhibit selectivity as a result of an inherent chemical recognition site are not common. This is particularly true for the case where the sensor is desired to respond in real time rather than in a dosimeter configuration.

State of the art real time sensors for formaldehyde are usually based on metal oxides, including some structures that incorporate conjugated polymers between metal oxide layers (Hosono 2005a; Itoh 2007a; Itoh 2007b; Itoh 2007c; Itoh 2008a; Itoh 2008b; Itoh 2008c; Zheng 2008). Others are based on electrochemical cells and many of these commercial formaldehyde sensors designed for ppb sensitivity have been demonstrated to be slow and unreliable, except for a very recent electrochemical sensor developed by Membrapor. However, all of these devices, including the Membrapor sensor, have significant cross-reactivity towards many other analytes including alcohols and water.

There exist a number of commercial dosimeters in the form of cartridges or tapes based on 2,4-dinitrophenylhydrazine that are selective and highly sensitive towards aldehydes and ketones, however, these dosimeters usually require off-line analysis with the aid of an HPLC. Although dosimeters can be very useful in many circumstances, real time monitoring is often desirable particularly when action is required if the formaldehyde concentration is above dangerous levels.

There has been a report of a polypyrrole-based sensor for formaldehyde and acetaldehyde (Hosono 2005b; Flueckiger 2009) but such sensors are still lacking in sensitivity. There has also been a report of a polyaniline gas sensor for sensing a variety of gases (Hosseini 2005). This report shows that the conductance of polyaniline changes under different concentrations of these various gases, including formaldehyde.

There has also been a report of a polyaniline-based sensor for detection of carbon monoxide (Dixit 2005). Carbon monoxide is an inorganic compound that behaves very differently from organic compounds containing carbonyl groups, e.g. aldehydes and ketones. For instance, carbon monoxide has a carbon-oxygen triple bond and does not react with amines unless catalyzed by transition metals, whereas aldehydes and ketone have carbon-oxygen double bonds and aldehydes react quite easily with amines. Thus, detection of carbon monoxide does not necessarily imply that a material should be sensitive to organic carbonyl species.

There remains a need in the art for sensors that are highly sensitive and selective towards organic carbonyl species, while being useful for real time monitoring.

### SUMMARY OF THE INVENTION

It has now been surprisingly found that sensors and methods based on metal oxide-free films of polyanilines provide selective, real time sensing of organic carbonyl species while providing faster response time than sensors and methods based on metal oxide/polyaniline structures and greater sensitivity than sensors and methods based on other conjugated polymers such as polypyrroles and polythiophenes. The present invention provides a better balance between sensitivity and response time than the prior sensors and methods.

There is provided a method for detecting organic carbonyl species comprising: exposing a metal oxide-free film of a polyaniline to an environment suspected of containing an organic carbonyl species; detecting a change in electrical conductivity and/or an optical or luminescent property of the polyaniline; and, correlating the change in electrical conductivity and/or optical or luminescent property to a presence of an organic carbonyl species in the environment.

There is further provided a sensor for organic carbonyl species comprising a metal oxide-free film of a polyaniline supported on an electrically insulating substrate.

Organic carbonyl species include, for example, aldehydes, ketones, carboylic acids, esters, amides and the like. The present invention is particularly useful for detecting aldehydes and ketones.

Polyanilines may be unsubstituted or substituted having one or more cyclic or acyclic substituents on the aromatic ring in one or more of the repeating units or directly attached to the nitrogen itself. Substituents preferably comprise one or more functional groups which can modify the nucleophilicity of the nitrogen of the aniline, and/or increase steric interactions near the nitrogen of the aniline or a secondary site for molecular recognition (e.g., boronic acid group). Interaction with an aldehyde or ketone may be thus tailored to further enhance detection specificity and/or sensitivity, for example by measuring differential responses of various polymeric films in an array format as is the case for an artificial nose. Such functional groups include, for example, alkyl groups, alkoxy groups, a nitro group, an amine, boronic acid, an ether or polyether, a halogen, an ester, an amide and a carboxylic acid. Preferred functional groups include alkyl groups, alkoxy groups, nitro or boronic acid. Boronic acid substituents are particularly preferred. Polyanilines are commercially available or may be readily synthesized by known methods (e.g. Freund 2004; Deore 2007).

Particularly preferred polyanilines are encompassed by Formula (I):

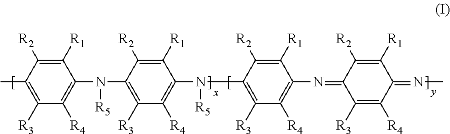

where x and y denote the number of reduced and oxidized repeating units, respectively, and x is an integer from 5 to 10,000, y is an integer from 0 to 10,000, provided that x+y equals an integer from 5 to 10,000. More preferably, x is an integer from 10 to 5,000. More preferably y is an integer from 0 to 5,000. More preferably, x+y equals an integer from 10 to 5,000. In a particularly preferred embodiment, x=y and this form is known as the Emeraldine base.

R₁, R₂, R₃, R₄ and R₅ are independently H or substituents having functional groups as described previously. More preferably, R₁, R₂, R₃, R₄ and R₅ are independently H, —C₁₋₆₀alkoxy, nitro, —C₁₋₆₀amine, —B(OH)₂, —C₁₋₆₀ether, —C₁₋₆₀polyether, halogen (e.g. F, Cl, Br or I), —C₁₋₆₀ester, —C₁₋₆₀carboxylic acid. Even more preferably, R₁, R₂, R₃, R₄ and R₅ are independently H, —C₁₋₈alkoxy, nitro, —C₁₋₈amine, —B(OH)₂, —C₁₋₈ether, —C₁₋₈polyether, halogen (e.g. F, Cl, Br or I), —C₁₋₈ester, —C₁₋₈amide or —C₁₋₈carboxylic acid. In the case where R₁, R₂, R₃, R₄ and R₅ are carbon-containing substituents, the substituents may be unbranched, branched or cyclic groups and they may be further substituted with another functional group, for example, nitro, —B(OH)₂, halogen. Yet more preferably, R₁, R₂, R₃, R₄ and R₅ are independently H, —C₁₋₈alkoxy, nitro or —B(OH)₂, even more preferably H, —CH₂CH₃, —OCH₃ or —B(OH)₂. Even yet more preferably, R₅ is H and one of R₁, R₂, R₃ or R₄ is —B(OH)₂ and the others of R₁, R₂, R₃ or R₄ are H.

Boronic acid (—B(OH)₂) functional groups are particularly preferred as they can react efficiently with 1,2-diols and 1,3-diols. Formaldehyde can exist in its hydrated state as methylene glycol, a germinal diol. Due to ring strain, this germinal diol may only react with one or two boronic acids (crosslinking) as depicted in Scheme 1. As a result, poly(anilineboronic acids) exhibit a much higher response towards formaldehyde than other polyanilines since there exists two possible sites for reaction with formaldehyde. The much higher response is manifested in both the electrical conductivity and optical properties of the poly(anilineboronic acids).

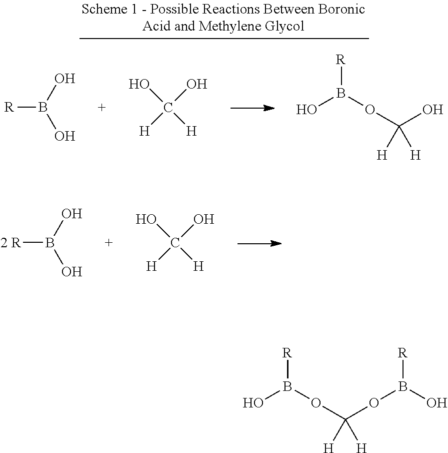

Since weight average molecular weights (M_{w}) depend on the nature of the substituents, unsubstituted polyaniline preferably has a M_{w} of about 500 g/mol or greater, preferably in a range of from about 500 g/mol to about 1,000,000 g/mol, or about 870 g/mol to about 500,000 g/mol. The M_{w} of substituted polyanilines can be determined accordingly by factoring in the contribution of the substituent to the molecular weight of the repeating unit.

The polyaniline may be a homopolymer or a copolymer. Copolymers may be formed by the copolymerization of differently substituted aniline monomer units. Other copolymers may comprise one or more non-aniline-based monomers along with one or more aniline-based monomers. Non-aniline-based monomers may be, for example, furans, pyrroles, thiophenes, phenyls, ethene (—C═C—), ethyne (—C≡C—), conjugated olefins (e.g. butadienes) and conjugated alkynes. Particularly preferred non-aniline-based monomers are thiophenes. Aniline-based monomers may be, for example, one or more monomers as defined above in connection with Formula (I). Preferably, the polyaniline is a homopolymer or a copolymer that only contains aniline-based monomers.

The polyaniline may be in its undoped state (base form) or doped with various degrees of doping levels. The doped forms are preferably formed by addition of a mineral acid, for example, HCl, HBr, H₂SO₄, etc., or an organic acid. Suitable organic dopants (acids) are generally known in the art and include, for example, sulfonic acids, phosphonic acids, phenols, carboxylic acids or mixtures thereof. These organic dopants may or may not be fluorinated and may include fluorinated alcohols which are rather acidic by virtue of the fluorine substituents. Of particular note are camphor-10-sulfonic acid (CSA), dinonylnaphthalenesulfonic acid (DNSA), dinonylnaphthalenedisulfonic acid (DNDSA), dodecylbenzenesulfonic acid (DBSA), cardanol azosulfonic acids, polyvinylphosphonic acid (PVPA), poly(alkylene phosphates), heptadecafluorooctanesulfonic acid, perfluorodecanoic acid, perfluorooctanoic acid and nonafluorobutane-1-sulfonic acid. Dodecylbenzenesulfonic acid (DBSA) or polyvinylphosphonic acid (PVPA) are preferred. Fluorinated organic dopants are especially useful since the hydrophobic fluorinated component reduces cross-sensitivity to water. Typically, polyanilines are prepared with its intrinsic doping level, which is of the order of 25-30% (mol/mol). For sensing applications, doping levels that range between 0-900% (mol/mol) are employed, however a doping level of 0.01-30% (mol/mol) is preferred particularly when monitoring electrical conductivity changes.

Primary amines (R—NH₂) have a tendency to react with aldehydes and ketones. For instance, it is well known that they react, in a reversible manner, with aldehydes to first form a carbinolamine intermediate which can form a Schiff-base in equilibrium due to the availability of the 2^{nd} hydrogen at the nitrogen. In the case of polyanilines, only the formation of the carbinolamine intermediate is possible (see Scheme 2) thereby providing recognition of aldehydes and ketones, although other mechanistic pathways may exist.

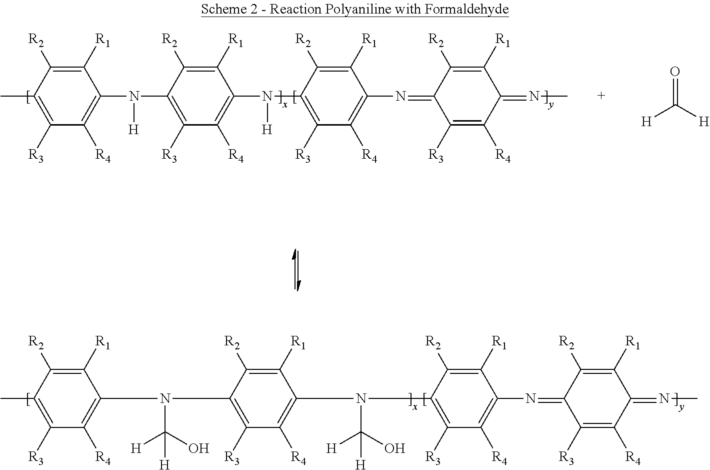

Perturbation of the polyaniline's conjugated electronic system due to reaction of the polyaniline with an organic carbonyl species can form the basis of its use in sensing the presence of the organic carbonyl species. Polyanilines possess two important physical properties by virtue of conjugation, electrical conductivity and optical/luminescent properties, which can change when their conjugated systems are perturbed. Measuring a change in electrical conductivity of the polyaniline, either by conductivity or resistivity techniques, or measuring a change in an optical/luminescent property of the polyaniline, for example by colorimetric analysis or spectroscopy, provides an indication that the polyaniline has undergone a reaction. Since the interaction of polyaniline and aldehydes/ketones is understood, the change in electrical conductivity or optical/luminescent property can be correlated to the presence of organic carbonyl species. Further enhancement of detection specificity and/or sensitivity of the polyaniline for an organic carbonyl species can be obtained by careful selection of substituents which can further increase or decrease the interaction with a particular organic carbonyl species. The measurement of the differential response between the polyaniline derivatives and the organic carbonyl species provides the means for the concept of an artificial nose (response from an array of polyanilines) which provides the means for a high degree of specificity in a quantitative manner. In addition, one can obtain qualitative and quantitative information from more than one component in a mixture of analytes.

Polyanilines may be synthesized through rational design to possess a differential response to different organic carbonyl species. Thus, changing the chemical structure of the polyaniline provides the ability to tune the response of the sensor. For instance, properly positioned electron donating groups in the polyaniline can effectively increase the nucleophilicity of the nitrogen and this will increase its response to ketones and sterically hindered aldehydes. Sensors comprising an array having different polyanilines can then be used to determine type and concentration of organic carbonyl species. Further, correlation curves can be established based on controlled measurements of electrical conductivity or optical/luminescent property of the polyaniline at known concentrations of organic carbonyl species, and measured differences in the electrical conductivity or optical/luminescent property of the polyaniline due to the presence of unknown organic carbonyl species can be compared to the correlation curves to determine the concentration of the unknown organic carbonyl species.

In a sensor, a thin metal oxide-free film of a polyaniline is supported on an electrically insulating substrate. The substrate comprises materials that are inert to the polyaniline as well as to as wide a range of environmental conditions as possible. Suitable inert materials include, for example, glass and polytetrafluoroethylene. Glass is particularly preferred. Inexpensive sensors may be fabricated by casting the polyaniline on to the substrate using generally known methods. Resistivity of the polyaniline thin film may be monitored with a commercial probe head from a probe station. In this case, the probes are brought into conformal contact with the film. Due to the nature of the films, a 4-probe configuration is preferred. Alternatively and preferably, a thin film of metallic lines (electrodes) may be deposited on the insulating substrate prior casting employing methods well known in the art. Resistivity measurement may be performed by making electrical contact with a set of custom-made or commercial probes on the exposed metallic lines (electrodes). The electrodes may comprise any suitable conductive material, for example gold, silver or other conductive metal. The conductive material is preferably inert to most environmental conditions. The conductive material is preferably gold. The electrodes may be configured in any suitable arrangement, and many suitable arrangements are well known in the art.

Response times of sensors of the present invention are on the order of about 60 seconds or less, even about 5 seconds or less, or even about 1 second or less. This is much faster than response times for metal oxide and metal oxide/polymer based sensors (Hosono 2005a Itoh 2007a; Itoh 2007b; Itoh 2007c; Itoh 2008a; Itoh 2008b; Itoh 2008c; Zheng 2008) which have response times on the order of 10-15 minutes. Levels of response or sensitivity of sensors of the present invention are greater than levels of response for other polymer-based sensors such as polypyrrole-based sensors. For example, the level of response for sensors of the present invention are at least twice as great as the level of response for polypyrrole-based sensors. For poly(anilineboronic acids), the level of response is even considerably greater. Thus, detection thresholds for sensors of the present invention are about 1 ppm or less. This is at least one order of magnitude better than the response from other polymer-based sensor, such as the polypyrrole-based sensors of the prior art (Hosono 2005b; Flueckiger 2009), which has a detection threshold of approximately 100 ppm. Although the present inventors have developed a polypyrrole-based sensor that has a similar response time as polyanilines with a threshold detection limit of approximately 2 orders of magnitude lower than the one reported by Hosono et al. (Hosono 2005a), in a direct comparison using the same instrumentation and the same conditions, polyaniline-based sensors were found to be superior with a higher response than polypyrrole-based sensors. Metal oxide- and metal oxide/polymer-based sensors have detection thresholds on the order of ppb's. Efforts to use films of a doped polythiophene derivative in sensors for aldehydes and ketones have been unsuccessful as the doped polythiophene was found not to respond to aldehydes and ketones and this is consistent with the postulated mechanism. Thus, sensors of the present invention demonstrate a good balance between response time and sensitivity, being considerably faster than metal oxide- and metal oxide/polymer-based sensors, while having greater sensitivity than other polymer-based sensors.

The sensor and method of the present invention are useful for gas sensing applications such as monitoring indoor air quality in residential or commercial buildings, monitoring levels of aldehyde and ketone species at industrial sites such wood-pressing manufacturing centers, detecting explosives and other applications where detection of aldehydes or ketones is important. In a particularly preferred embodiment, the sensor and method of the present invention are useful for detecting formaldehyde.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1A is a schematic drawing depicting one embodiment of a sensor having a 4-probe design of gold electrodes on a circular glass substrate over which a thin film of doped polyaniline is cast;

FIG. 1B is a schematic drawing depicting another embodiment of a sensor having a 4-probe design of gold electrodes on a circular glass substrate over which a thin film of doped polyaniline is cast;

FIG. 2A depicts a graph (left) of electrical resistance of polyaniline as a function of fractional doping level using polyvinylphosphonic acid (PVPA) as a dopant, and, graphs (right) of electrical resistance changes over time as a result of exposure of doped polyaniline to 40 ppm formaldehyde for 7.5% (mol/mol) doped polyaniline (upper) and 25% (mol/mol) doped polyaniline (lower);

FIG. 2B depicts a graph of electrical resistance changes over time as a result of exposure of doped polyaniline to 2.4 ppm formaldehyde for 10% (mol/mol) polyvinylphosphonic acid (PVPA) doped polyaniline;

FIG. 2C depicts a graph (left) of electrical resistance of polyaniline as a function of fractional doping level using polyvinylphosphonic acid (PVPA) as a dopant, and, graphs (right) of electrical resistance changes over time as a result of exposure of doped polyaniline to 300 ppb formaldehyde for 10% (mol/mol) doped polyaniline (upper) and 20% (mol/mol) doped polyaniline (lower);

FIG. 2D depicts a graph of electrical resistance changes over time as a result of exposure of doped polyaniline to 250 ppb formaldehyde at a relative humidity of 44% for 10% (mol/mol) polyvinylphosphonic acid (PVPA) doped polyaniline;

FIG. 3 depicts electrical resistance response as a function of time for polyaniline (a) and poly(o-anisidine) (b) doped with dodecylbenzenesulfonic acid (DBSA) when exposed to acetone;

FIG. 4A depicts electrical resistance response as a function of time for poly(aniline-co-3-nitroaniline) doped with polyvinylphosphonic acid (PVPA) when exposed to 10 ppm acetaldehyde; and,

FIG. 4B depicts electrical resistance response as a function of time for poly(aniline-co-3-nitroaniline) doped with polyvinylphosphonic acid (PVPA) when exposed to 0.920 ppm formaldehyde;

FIG. 5 depicts electrical resistance response as a function of time for polypyrrole doped with phosphomolybdic acid when exposed to 40 ppm formaldehyde; and,

FIG. 6 depicts electrical resistance response as a function of time for polythiophene doped with phosphomolybdic acid when exposed to formaldehyde.

### DESCRIPTION OF PREFERRED EMBODIMENTS

### Example 1

### Sensor Configurations

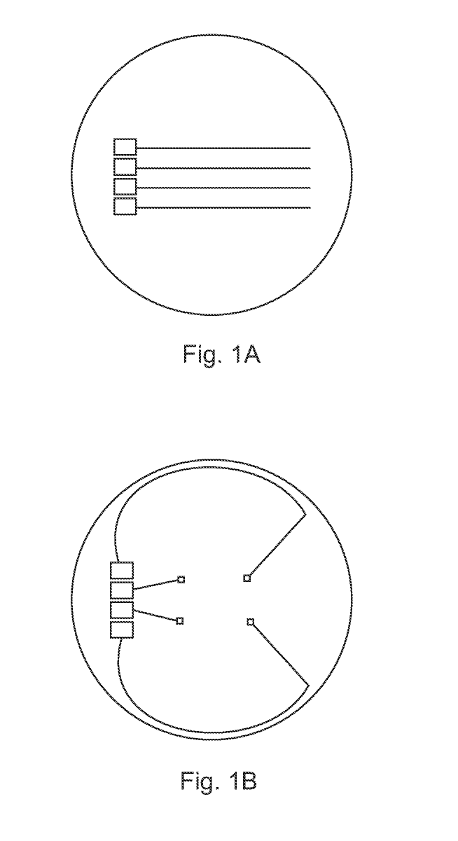

Referring to FIGS. 1A and 1B, two embodiments of sensor configurations are depicted each having a 4-probe design of gold electrodes on a circular glass substrate over which a thin film of doped polyaniline is cast. The design of FIG. 1B provides a more stable signal that is less prone to interference due to mechanical vibration. The design of FIG. 1A may be optimized for greater sensitivity by decreasing the gap between the four electrodes, for example, by 100-fold.

### Example 2

### Polyaniline Homopolymer Doped with Polyvinylphosphonic Acid

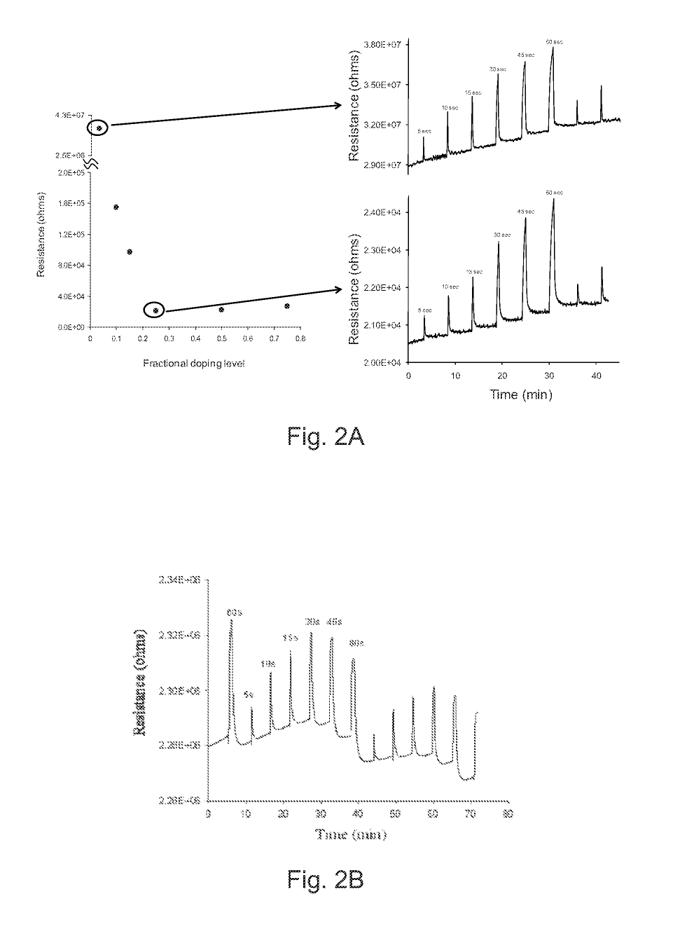

Electrical conductivity measurements are presented in FIG. 2 for polyaniline homopolymer doped with polyvinylphosphonic acid (PVPA) at different doping levels.

Referring to FIG. 2A, electrical resistance as measured using the 4-probe sheet sensor of polyaniline as illustrated in FIG. 1B was examined as a function of doping level with polyvinylphosphonic acid (PVPA). Change in electrical resistance of the doped polyaniline thin films is illustrated for the 7.5% (mol/mol) and 25% (mol/mol) doping levels when plugs of formaldehyde are injected in air at a concentration of approximately 40 ppm for different lengths of time. It is evident from the graphs on the right in FIG. 2A that the micron thin films have a change in resistance, i.e. a response, on the order of about 20%. The greatest response occurred at about 60 seconds after exposure to formaldehyde, but the time to a recordal response is as little as about 5 seconds. Further, the greatest drop in resistance occurs at a fractional doping level of about 0.25.

Referring to FIG. 2B, electrical resistance as measured using the 4-probe sheet sensor of polyaniline as illustrated in FIG. 1B was examined at a polyvinylphosphonic acid (PVPA) doping level of 10% (mol/mol) when plugs of formaldehyde were injected in air at a concentration of approximately 2.4 ppm for different lengths of time. Its is evident that a response is obtained in as little as 5 seconds and that a maximum response of about 2.2% occurs between about 30 and 60 seconds. FIG. 2B illustrates that the sensitivity of the polyaniline sensor can be as little as about 2.4 ppm or less, and from the magnitude of the response, it is evident that sub-ppm detection can be achieved.

The 4-probe sheet sensor depicted in FIG. 1A comprising a thin film of polyaniline was optimized by narrowing electrode gap by a factor of 100. A set of resistance experiments was conducted in a manner similar to the ones described above. Referring to FIG. 2C, electrical resistance as measured using the optimized 4-probe sheet sensor was examined as a function of doping level with polyvinylphosphonic acid (PVPA). Change in electrical resistance of the doped polyaniline thin films is illustrated for the 10% (mol/mol) and 20% (mol/mol) doping levels when plugs of formaldehyde are injected in air at a concentration of approximately 300 ppb under anhydrous conditions for different lengths of time. It is evident from the graphs on the right in FIG. 2C that the micron thin films have a change in resistance, i.e. a response, on the order of about 0.5% to 1.1%. The greatest response occurred at about 60 seconds after exposure to formaldehyde, but the time to a recordable response is as little as about 5 seconds. Further, the greatest drop in baseline resistance occurs at a fractional doping level of about 0.2. However, higher sensitivity is observed at a fractional doping level of 0.1. This example illustrates the capability of the present sensors to detect formaldehyde even at the ppb level, demonstrating the remarkable sensitivity of the sensors.

Referring to FIG. 2D, electrical resistance as measured using the optimized polyaniline 4-probe sheet sensor was examined at a polyvinylphosphonic acid (PVPA) doping level of 10% (mol/mol) when plugs of formaldehyde were injected in air at a concentration of approximately 250 ppb at a relative humidity of about 44% for different lengths of time. The sensor was equilibrated to the prescribed level of humidity. It is evident that a response is obtained in as little as 5 seconds and at a maximum response of about 0.32%. FIG. 2D establishes that the polyaniline sensor can detect ppb levels of formaldehyde even under humid conditions. A relative humidity of 40-50% is considered to be comfort level.

### Example 3

### Polyaniline and Poly(O-Anisidine) Doped with Dodecylbenzene Sulfonic Acid

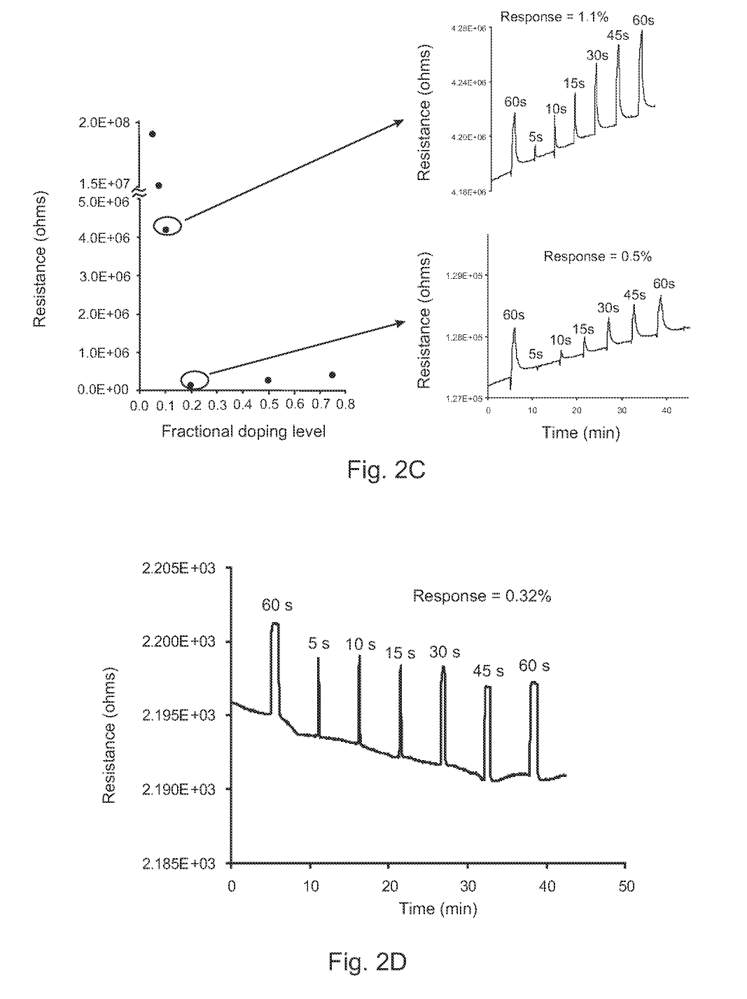

Electrical conductivity measurements are presented in FIG. 3a for thin films of polyaniline doped with 125% (mol/mol) dodecylbenzenesulfonic acid (DBSA) and in FIG. 3b for thin films of poly(o-anisidine) doped with 75% (mol/mol) dodecylbenzene sulfonic acid (DBSA) when exposed to acetone. The response for the polyaniline (FIG. 3a) is consistent with a solvation effect. The response for the poly(o-anisidine) (FIG. 3b) is consistent with a reversible chemical reaction between acetone and the poly(o-anisidine). The results indicate that altering nucleophilicity of the polymer as in poly(o-anisidine) as well as optimizing the doping level can permit tuning to specific organic carbonyl species or specific groups of organic carbonyl species.

### Example 4

### Poly(Aniline-Co-3-Nitroaniline) Doped with Dodecylbenzenesulfonic Acid

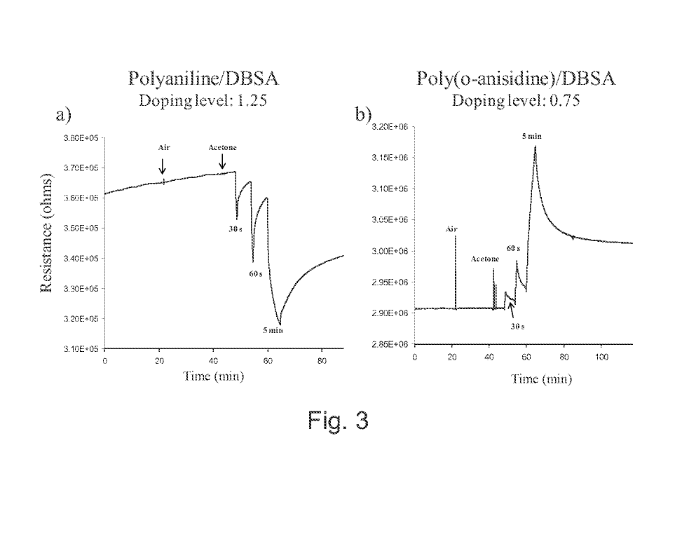

In this example, a sensor based on a polyaniline copolymer was tested for its selectivity towards acetaldehyde (CH₃CHO) and formaldehyde (HCHO). Referring to FIG. 4A, electrical resistance as measured using a poly(aniline-co-3-nitroaniline) 4-probe sheet sensor was examined at a dodecylbenzenesulfonic acid (DBSA) doping level of 75% (mol/mol) when plugs of acetaldehyde were injected in air at a concentration of approximately 10 ppm for different lengths of time. It is evident that a response is obtained in as little as 5 seconds and at a maximum response of about 24.5%. Referring to FIG. 4B, electrical resistance as measured using a poly(aniline-co-3-nitroaniline) 4-probe sheet sensor was examined at a dodecylbenzenesulfonic acid (DBSA) doping level of 75% (mol/mol) when plugs of formaldehyde were injected in air at a concentration of approximately 0.92 ppm for different lengths of time. It is evident that a response is obtained in as little as 5 seconds and at a maximum response of about 51.5%. FIGS. 4A and 4B that the response is much higher for formaldehyde than acetaldehyde at the same concentrations (response to acetaldehyde at 0.92 ppm would be 2.3%) making the device 22 times more responsive to formaldehyde. This is in contrast to polyaniline/PVPA system at 10% doping level where the sensor is 10 times more responsive towards formaldehyde. This demonstrates the ability to tailor the chemical structure of the polymer to induce a higher degree of selectivity to a particular analyte. This will very useful in designing artificial noses.

Table 1 compares the response of the poly(aniline-co-3-nitroaniline) sensor to acetaldehyde and formaldehyde at doping levels of DBSA of 50% (mol/mol), 75% (mol/mol) and 100% (mol/mol). In the third column of Table 1, the response to acetaldehyde is normalized to 0.92 ppm in order to compare it with the response to formaldehyde. It is evident from the selectivity factor that the poly(aniline-co-3-nitroaniline) sensor is well capable of resolving acetaldehyde and formaldehyde despite the chemical similarities between the two (a most difficult system). In the art, the acetaldehyde/formaldehyde system has hitherto been a difficult one to resolve, however, the present sensors remarkably have the ability to resolve that system.

TABLE 1

| | | | | Selectivity |
|---|---|---|---|---|
| | Response to | Response to | Response to | Factor |
| Fractional | CH₃CHO | CH₃CHO | HCHO | (HCHO/ |
| doping level | (10 ppm) | (0.92 ppm) | (0.92 ppm) | CH₃CHO) |
| 0.5 | 56.0% | 5.2% | 44.0% | 8.5 |
| 0.75 | 24.5% | 2.3% | 51.5% | 23 |
| 1.0 | 30.5% | 2.8% | 39.3% | 14 |

### Example 5

### Poly(Anilineboronic Acid) Doped with Phosphoric Acid

In this example and with reference to Table 2, a sensor based on a poly(anilineboronic acid) was tested for its ability to resolve acetaldehyde and formaldehyde. Electrical resistance as measured using a poly(anilineboronic acid) 4-probe sheet sensor was examined at various phosphoric acid doping levels when plugs of acetaldehyde (CH₃CHO, 10 ppm) or formaldehyde (HCHO, 2 ppm) were injected in air for different lengths of time. In the undoped sample, no phosphoric acid was used to dope the poly(anilineboronic acid). In the fully doped case, the poly(anilineboronic acid) is doped with more than 100% (mol/mol) of phosphoric acid. In the semi-doped case, the level of phosphoric acid doping varies in the transverse direction of the poly(anilineboronic acid) film. The maximum response at each doping level to each aldehyde is shown in Table 2. Table 2 further compares the response of the poly(anilineboronic acid) sensor to acetaldehyde and formaldehyde at each doping level of phosphoric acid. In the third column of Table 2, the response to acetaldehyde is normalized to 2 ppm in order to compare it with the response to formaldehyde. It is evident from the selectivity factor that the poly(anilineboronic acid) sensor is well capable of resolving acetaldehyde and formaldehyde despite the chemical similarities between the two, further testifying to the remarkable ability of the present sensors to resolve the difficult acetaldehyde/formaldehyde system.

TABLE 2

| | | | | Selectivity |
|---|---|---|---|---|
| | Response to | Response to | Response to | Factor |
| | CH₃CHO | CH₃CHO | HCHO | (HCHO/ |
| Doping level | (10 ppm) | (2 ppm) | (2 ppm) | CH₃CHO) |
| Undoped | 5.2% | 1.0% | 7.9% | 8 |
| Semi doped | 2.0% | 0.5% | 7.9% | 20 |
| Fully doped | 10.5% | 2.1% | 6.4% | 3 |

### Example 6

### Comparison of Sensors Based on Polyanilines to Prior Art Sensors

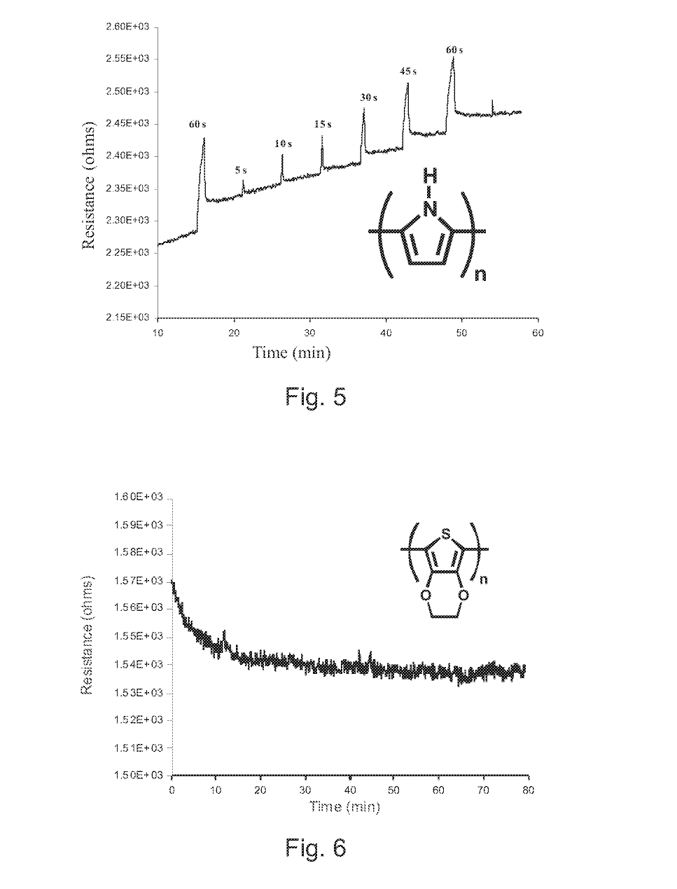

Prior art metal oxide and metal oxide/polymer based sensors (Hosono 2005a; Itoh 2007a; Itoh 2007b; Itoh 2007c; Itoh 2008a; Itoh 2008b; Itoh 2008c; Zheng 2008) generally have detection limits at the ppb level, however, they are typically plagued by extremely slow response times. Japanese patent publication 2007-271598 (Itoh 2007c), which discloses a sensor comprising a film of polyaniline intercalated between molybdenum oxide layers is typical of such sensors. It is evident from FIGS. 6, 8 and 10 of Itoh 2007c that the response time is on the order of 10-15 minutes, which is consistent with other metal-oxide-based sensors in which response is due to change in resistance of the metal oxide. As indicated above, response time for sensors of the present invention is less than 5 seconds.

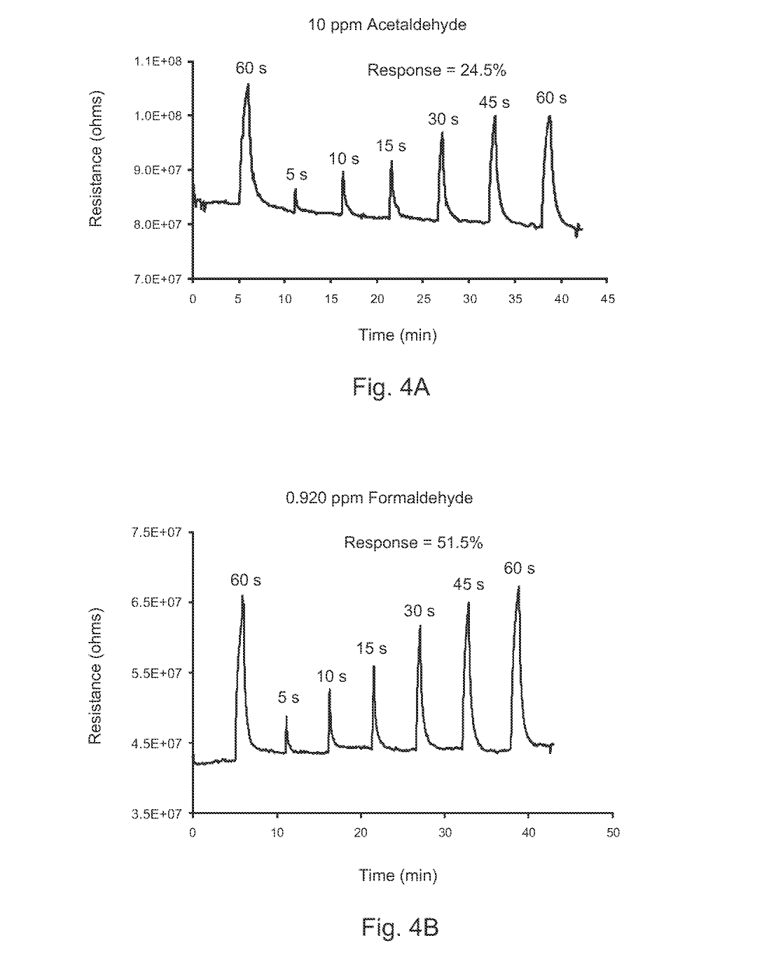

Polymer-based sensors, such as polypyrrole-based sensors, polyaniline-based sensors and polythiophene-based sensors have been proposed (Flueckiger 2009), however, only polypyrrole-based sensors (Hosono 2005b) have been characterized. As evident from Hosono 2005b, their polypyrrole-based sensor has a response time of about 300 seconds (page 397, section 3 and FIG. 1 of Hosono 2005b) and a detection limit of about 100 ppm (FIG. 4 of Hosono 2005b) for acetaldehyde. In an experiment by the current inventors (FIG. 5) a thin film of polypyrrole doped with phosphomolybdic acid was exposed to formaldehyde under the same conditions as in FIG. 2A of Example 2 and the change in resistance was monitored as a function of time. As evidenced in FIG. 5, the response time was on the order of less than 5 seconds, comparable to the results for polyaniline-based sensors, but the maximum response (at 60 seconds) was less than about 8%, which is considerably less than the at least 20% response from polyaniline-based sensors of the present invention. Further, a similar experiment with phosphomolybdic acid-doped poly(3,4-ethylenedioxythiophene) (PDOT) was attempted but no response at all to formaldehyde was obtained (FIG. 6). Clearly, polypyrrole-based sensors and polythiophene-based sensors do not function as well as the polyaniline-based sensors of the present invention.

Thus, sensors of the present invention based on metal oxide-free thin films of polyanilines demonstrate a good balance between response time and sensitivity, being considerably faster than metal oxide and metal oxide/polymer based sensors, while having greater sensitivity than other polymer-based sensors.

### REFERENCES

The contents of the entirety of each of which are incorporated by this reference.
Deore B, Yu I, Freund M S. (2007) “Switchable Self-Doped Polyaniline”. US Patent Publication 2007/093644 published Apr. 26, 2007.
Dixit V, Misra S C K, Sharma B S. (2005) “Carbon monoxide sensitivity of vacuum deposited polyaniline semiconducting thin films”. Sensors and Actuators B. 104, 90-93.
Flueckiger, J Ko F K, Cheung K C. (2009) “Microfabricated Formaldehyde Gas Sensors”. Sensors. 9, 9196-9215.
Freund M S, Shoji E. (2004) “Synthesis of Substituted Poly(aniline)s”. U.S. Pat. No. 6,737,504 issued May 18, 2004.
Hosono K, Matsubara I, Murayama N, Shin W, Izu N. (2005a) “Synthesis of Polypyrrole/MoO₃ Hybrid Thin Films and Their Volatile Organic Compound Gas-Sensing Properties”. Chemistry of Materials. 17(2), 349-354.
Hosono K, Matsubara I, Murayama N, Shin W, Izu N. (2005b) “The sensitivity of 4-ethylbenzenesulfonic acid-doped plasma polymerized polypyrrole films to volatile organic compounds”. Thin Solid Films. 484, 396-399.
Hosseini S H, Oskooei S H A, Entezam A A. (2005) Toxic Gas and Vapour Detection by Polyaniline Gas Sensors. Iranian Polymer Journal. 14(4), 333-344.
Itoh T, Matsubara I, Shin W, Izu N. (2007a) “Layered hybrid thin film of molybdenum trioxide with poly(2,5-dimethylaniline) for gas sensor sensitive to VOC gases in ppm level”. Chemistry Letters. 36(1), 100-101.
Itoh T, Matsubara I, Shin W, Izu N. (2007b) “Synthesis and characterization of layered organic/inorganic hybrid thin films based on molybdenum trioxide with poly(N-methylaniline) for VOC sensor”. Materials Letters. 61, 4031-4034.
Itoh T, Matsubara I, Shin U, Izu N. (2007c) “Gas Sensor and Method for Manufacturing Same”. Japanese Patent Publication JP 2007-271598 published Oct. 18, 2007.
Itoh T, Wang J, Matsubara I, Shin W, Izu N, Nishibori M, Murayama N. (2008a) “VOCs sensing properties of layered organic-inorganic hybrid thin films: MoO₃ with various interlayer organic components”. Materials Letters. 62, 3021-3023
Itoh T, Matsubara I, Shin W, Izu N, Nishibori M. (2008b) “Preparation of layered organic-inorganic nanohybrid thin films of molybdenum trioxide with polyaniline derivatives for aldehyde gases sensors of several tens ppb level”. Sensors and Actuators B. 128, 512-520.
Itoh T, Matsubara I, Shin W, Izu N. (2008c) “High Sensitive Gas Sensor and its Manufacturing Process”. US Patent Publication 2008/0118404 published May 22, 2008.
Ji J. (2006) “Method for Producing Defect Free Composite Membranes”. US Patent Publication 2006/0000766 published Jan. 5, 2006.
Minteer S D, Akers N L, Moore C M. (2004) “Enzyme Immobilization for Use in Biofuel Cells and Sensors”. US Patent Publication 2004/0101741 published May 27, 2004.
Mustonen T. (2007) “A Method of Building a Sensor Structure”. International Patent Publication WO 2007/006844 published Jan. 18, 2007.
Wang J, Matsubara I, Murayama N, Woosuck S, Izu N. (2006) “The preparation of polyaniline intercalated MoO₃ thin film and its sensitivity to volatile organic compounds”. Thin Solid Films. 514, 329-333.
Zheng J, Li G, Ma X, Wang Y, Wu G, Cheng Y. (2008) “Polyaniline-TiO₂ nano-composite-based trimethylamine QCM sensor and its thermal behavior studies”. Sensors and Actuators B. 133, 374-380.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method for detecting an organic carbonyl species comprising: exposing a metal oxide-free film of a polyaniline to an environment suspected of containing an organic carbonyl species; detecting a change in electrical conductivity and/or an optical or luminescent property of the polyaniline; and, correlating the change in electrical conductivity and/or optical or luminescent property to a presence of an organic carbonyl species in the environment.

2. The method according to claim 1, wherein the polyaniline is a copolymer comprising one or more aniline-based monomers and one or more non-aniline-based monomers selected from the groups consisting of furans, pyrroles, thiophenes, phenyls, ethene, ethyne, conjugated olefins and conjugated alkynes.

3. The method according to claim 1, wherein the polyaniline is a copolymer comprising one or more aniline-based monomers and one or more thiophenes.

4. The method according to claim 1, wherein the polyaniline is a compound of Formula (I): 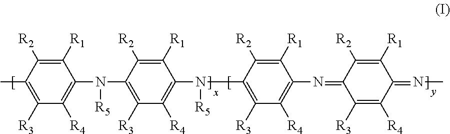
where:
x is an integer from 5 to 10,000 and y is an integer from 0 to 10,000, provided that x+y equals an integer from 5 to 10,000; and,
R₁, R₂, R₃, R₄ and R₅ are independently H, —C₁₋₆₀alkyl, —C₁₋₆₀alkoxy, nitro, —C₁₋₆₀amine, —B(OH)₂, —C₁₋₆₀ether, —C₁₋₆₀polyether, halogen, —C₁₋₆₀ester, —C₁₋₆₀amide or —C₁₋₆₀carboxylic acid.

5. The method according to claim 4, wherein x=y.

6. The method according to claim 4, wherein R₁, R₂, R₃, R₄ and R₅ are independently H, —C₁₋₈alkyl, —C₁₋₈alkoxy, nitro, —C₁₋₈amine, —B(OH)₂, —C₁₋₈ether, —C₁₋₆₀polyether, halogen (e.g. F, Cl, Br or I), —C₁₋₈ester, —C₁₋₈amide or —C₁₋₈carboxylic acid.

7. The method according to claim 4, wherein R₁, R₂, R₃, R₄ and R₅ are independently H, —C₁₋₈alkyl, —C₁₋₈alkoxy, nitro or —B(OH)₂.

8. The method according to claim 4, R₅ is H and one of R₁, R₂, R₃ or R₄ is —CH₂CH₃, —OCH₃ or —B(OH)₂ and the others of R₁, R₂, R₃ or R₄ are H.

9. The method according to claim 4, wherein R₅ is H and one of R₁, R₂, R₃ or R₄ is —B(OH)₂ and the others of R₁, R₂, R₃ or R₄ are H.

10. The method according to claim 1, wherein the polyaniline is doped with one or more dopants.

11. The method according to claim 10, wherein the one or more dopants comprises camphor-10-sulfonic acid (CSA), dinonylnaphthalenesulfonic acid (DNSA), dinonylnaphthalenedisulfonic acid (DNDSA), dodecylbenzenesulfonic acid (DBSA), cardanol azosulfonic acids, polyvinylphosphonic acid (PVPA), poly(alkylene phosphates), heptadecafluorooctanesulfonic acid, perfluorodecanoic acid, perfluorooctanoic acid and nonafluorobutane-1-sulfonic acid.

12. The method according to claim 10, wherein the one or more dopants are present in a doping level of up to 900% (mol/mol).

13. The method according to claim 1, wherein a change in electrical conductivity is detected.

14. The method according to claim 1, wherein the organic carbonyl species comprises an aldehyde or a ketone.

15. A sensor for organic carbonyl species comprising a metal oxide-free film of a polyaniline supported on an electrically insulating substrate.

16. The sensor according to claim 15, further comprising electrodes for monitoring change in resistance of the polyaniline.

17. The sensor according to claim 15, wherein the polyaniline is a copolymer comprising one or more aniline-based monomers and one or more non-aniline-based monomers selected from the groups consisting of furans, pyrroles, thiophenes, phenyls, ethene, ethyne, conjugated olefins and conjugated alkynes.

18. The sensor according to claim 15, wherein the polyaniline is a copolymer comprising one or more aniline-based monomers and one or more thiophenes.

19. The sensor according to claim 15, wherein the polyaniline is a compound of Formula (I): 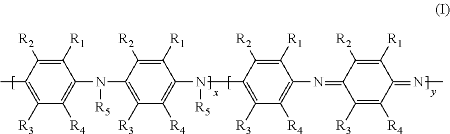
where:
x is an integer from 5 to 10,000 and y is an integer from 0 to 10,000, provided that x+y equals an integer from 5 to 10,000; and,
R₁, R₂, R₃, R₄ and R₅ are independently H, —C₁₋₆₀alkyl, —C₁₋₆₀alkoxy, nitro, —C₁₋₆₀amine, —B(OH)₂, —C₁₋₆₀ether, —C₁₋₆₀polyether, halogen, —C₁₋₆₀ester, —C₁₋₆₀amide or —C₁₋₆₀carboxylic acid.

20. The sensor according to claim 19, wherein x=y.

21. The sensor according to any one of claim 19, wherein R₁, R₂, R₃, R₄ and R₅ are independently H, —C₁₋₈alkoxy, nitro, —C₁₋₈amine, —B(OH)₂, —C₁₋₈ether, —C₁₋₆₀polyether, halogen, —C₁₋₈ester, —C₁₋₆₀amide or —C₁₋₈carboxylic acid.

22. The sensor according to claim 19, R₅ is H and one of R₁, R₂, R₃ or R₄ is —CH₂CH₃, —OCH₃ or —B(OH)₂ and the others of R₁, R₂, R₃ or R₄ are H.

23. The sensor according to claim 19, wherein R₅ is H and one of R₁, R₂, R₃ or R₄ is —B(OH)₂ and the others of R₁, R₂, R₃ or R₄ are H.

24. The sensor according claim 15, wherein the polyaniline is doped with one or more dopants.

25. The sensor according to claim 24, wherein the one or more dopants comprises camphor-10-sulfonic acid (CSA), dinonylnaphthalenesulfonic acid (DNSA), dinonylnaphthalenedisulfonic acid (DNDSA), dodecylbenzenesulfonic acid (DBSA), cardanol azosulfonic acids, polyvinylphosphonic acid (PVPA), poly(alkylene phosphates), heptadecafluorooctanesulfonic acid, perfluorodecanoic acid, perfluorooctanoic acid and nonafluorobutane-1-sulfonic acid.

26. The sensor according to claim 24, wherein the one or more dopants are present in a doping level of up to 900% (mol/mol).
